(19) United States
(12) Patent Application Publication
(10) Pub. No.: US 2025/0105959 A1
(43) Pub. Date: Mar. 27, 2025

(54) Real-Time PHY model at RAN Edge

(71) Applicant: Parallel Wireless, Inc., Nashua, NH (US)

(72) Inventors: Nihar Nanda, Acton, MA (US); Erez Biton, Herzlia (IL); David Khemelevsky, Kfar Sava (IL)

(21) Appl. No.: 18/893,960

(22) Filed: Sep. 23, 2024

Related U.S. Application Data
(60) Provisional application No. 63/584,672, filed on Sep. 22, 2023.

(51) Int. Cl. H04L 5/00; H04W 24/02

(52) U.S. Cl. CPC H04L 5/0044; H04W 24/02

(57) ABSTRACT

A method for providing a Real-Time PHY model at a RAN edge involves running an Artificial Intelligence (AI) model on a general-purpose processor in the cloud using telecommunications data as inputs to generate outputs. These inputs and outputs are stored in a lookup format to facilitate lookup without concurrently storing the AI model. The stored inputs and outputs are then deployed to a Virtual Base Band Unit (VBBU), where in-memory lookup of parameters is used for real-time telecommunications data. The method may also include storing the inputs and outputs with compression and periodically refreshing them by re-running the AI model and deploying a new lookup format to the VBBU. The telecommunications data can be radio frequency physical layer data or 4G/5G media access control (MAC) layer data.

### CROSS-REFERENCE TO RELATED APPLICATIONS

The present application claims the benefit of priority to, and is a non-provisional conversion of, U.S. Provisional Patent App. No. 63/584,672, filed Sep. 22, 2023 and having the same title as the present application, which is also hereby incorporated by reference in its entirety. The present application also hereby incorporates by reference U.S. Pat. App. Pub. Nos. US20110044285; US20140241316; US20230291646A1; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019; and U.S. patent application Ser. No. 18/582,475, “RAN Centralization Solution.”

### BACKGROUND

A Virtualized Base Band Unit (VBBU) centralizes processing and allows co-location and pooling of baseband resources for a localized cluster of cell sites, leading to spectral efficiency gains via coordination, and Capital Expenditures (CAPEX)/operating expenses (OPEX) saving by reducing the number of sites and per site expenses. A VBBU brings the architecture of a Distributed Unit (DU) and a Central Unit (CU), deployed at the network's edge. The VBBU resources can be shared among multiple Remote Radio Units (RRUs) on-site in a multi-carrier 1-sector, 3-sector or 6-sector configurations to achieve optimal resource pooling for Total cost of Ownership (TCO) savings. VBBU delivers higher availability, reliability, and scalability.

### SUMMARY

In one embodiment, a method is disclosed for providing a Real-Time PHY model at a RAN edge, comprising: running an Artificial Intelligence (AI) model on a general purpose processor in a cloud using telecommunications data as inputs, to generate outputs; storing the inputs and the outputs in a lookup format to facilitate lookup, without storing the AI model concurrently; deploying the stored inputs and outputs in the lookup format to a Virtual Base Band Unit (VBBU); and using in-memory lookup of parameters at the VBBU of real time telecommunications data.

The method may further comprise storing the inputs and the outputs with compression. The method may further comprise refreshing the stored inputs and outputs by re-running the AI model periodically and deploying a new lookup format to the VBBU. The telecommunications data may be radio frequency physical layer data. The telecommunications data may be 4G or 5G media access control (MAC) layer data.

### BRIEF DESCRIPTION OF THE DRAWINGS

FIG. 1 is a schematic drawing of an ORAN-compatible network architecture for one or more radio access technologies, including showing AI and ML models being deployed among those layers, in accordance with some embodiments.

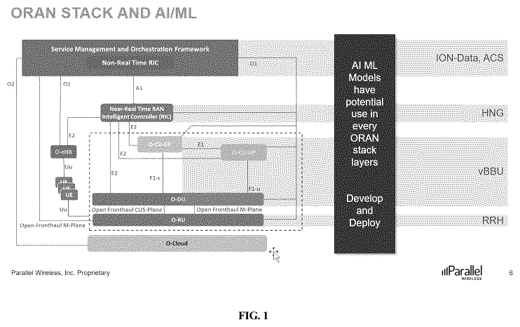

FIG. 2 is a depiction of deployment strategies for AI/ML apps within a telecommunications network, in accordance with some embodiments.

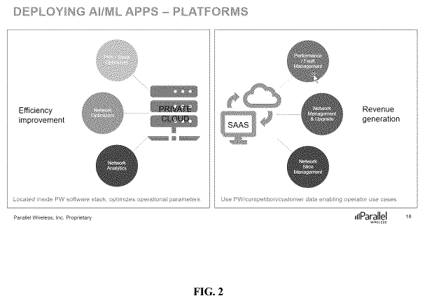

FIG. 3 is a diagram of key areas for AI/ML deployment, in accordance with some embodiments.

FIG. 4 is a diagram of a multi-RAT ORAN-compatible deployment architecture, in accordance with some embodiments.

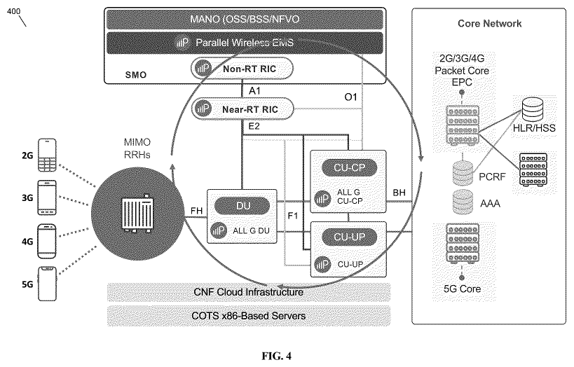

FIG. 5 is a further diagram of a multi-RAT ORAN-compatible deployment architecture, in accordance with some embodiments.

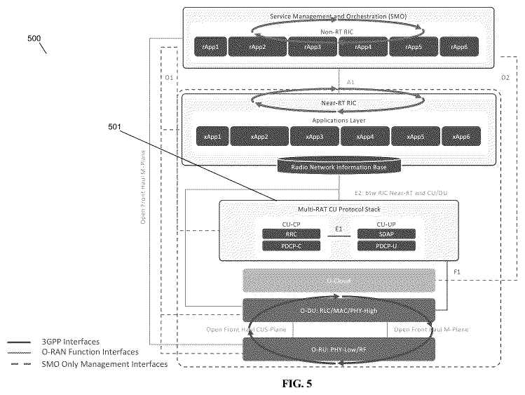

FIG. 6 is a diagram of a service management and orchestration framework, in accordance with some embodiments.

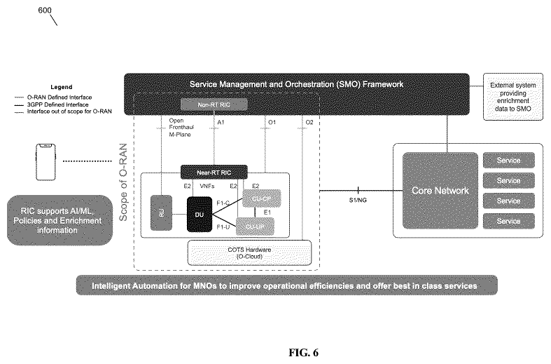

FIG. 7 is a diagram of a service management and orchestration framework in operation, in accordance with some embodiments.

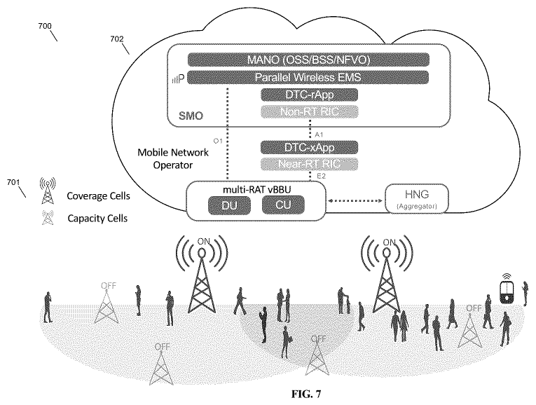

### DETAILED DESCRIPTION

There is a need to collapse everything to fit the model into the VBBU. There is academic research showing feasibility of AI models; and some people are doing models in application layer but these are not the right layer. Should be in lower layers: transport, network, MAC, PHY.

Where the academic models are successful: network layer and MAC layer. We want to run these models in our VBBU. The challenge: how to run an AI model on general purpose CPU (e.g., x86, ARM, others) in VBBU with a very tight timing requirement.

For some of these very time sensitive things, sub milliseconds, like resource allocation-we are thinking about using in-memory lookup of parameters and we can download that to the VBBU. For this purpose, an AI model would be trained and then subsequently, a range of input parameters corresponding to the specific VBBU system can be fed to the model, with the resultant outputs being captured. These inputs and outputs can be saved separately from the model. The inputs and outputs can be retained as a lookup table, here called an “AI lookup table.” We can refresh that from time to time using a new output set from the trained AI model. In some embodiments, we can simply take the AI model itself out, but just retain a mapping from the inputs to the outputs, store that in memory or a lookup table. Compression can be used on the lookup table, in some embodiments. This is inside the radio physical layer and/or radio upper layer stack software, in some embodiments. It is desirable (although not required) to use an in-memory lookup table, as computation within the VBBU must operate within a very strict time budget, in some embodiments.

In some cases, the mappings may be simple for some inputs but may be complex for other inputs, e.g., there may be boundary conditions. But the models themselves don't do well at boundaries. We have computed a model based on assuming a certain boundary. In some cases, it is desirable to enable prediction even without having enough CPU for a model in this real-time environment. In such a situation it is possible for the skilled artisan to make an intelligent guess, what the inputs are, in some embodiments. What if the inputs are not within the range we expect? Then we need to intelligently predict an output. Some kind of output at the boundary. In some embodiments, the input parameters can be analyzed, either manually or by a heuristic or by an AI model (a different model), and the input parameters that are the most likely to occur may be identified and input to the PHY/MAC AI model to generate the desired outputs and AI lookup table.

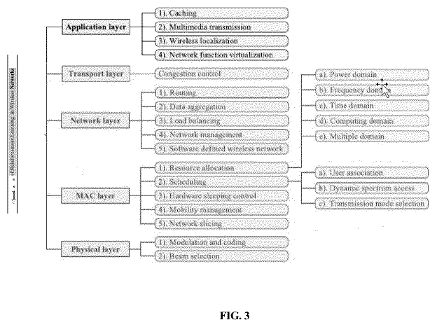

Academic research proves feasibility of Al models in optimizing networks at low latency. In many instances Al models are at-par or outperformed traditional alogs. RL Al models used in the research are trained using simulated data in majority of cases. Many RL models required small number of episodes for training. The identified use cases in FIG. 3 represent models in access and network domains.

Specifically at least: 1). Caching Application layer 2). Multimedia transmission 3). Wireless localization 4). Network function virtualization Transport layer Congestion control (a). Power domain 1). Routing b). Frequency domain (2). Data aggregation c). Time domain Network layer (3). Load balancing d). Computing domain (4). Network management (c). Multiple domain 5). Software defined wireless network 1). Resource allocation a). User association (2). Scheduling b). Dynamic spectrum access MAC layer 3). Hardware sleeping control c). Transmission mode selection 4). Mobility management (5). Network slicing 1). Modulation and coding Physical layer 2). Beam selection

This idea can be used generally to provide minimized or compressed predictive support at the vBBU for other AI models. For example, predicting performance and fault management using an AI model and then compressing the output into an AI lookup table for deployment to the VBBU could be enabled in some embodiments. Another embodiment would be to provide cell failure prediction using an AI Model, where the output can be compressed and deployed to the VBBU, in some embodiments. Another embodiment would be to provide cell drop rate prediction, or energy usage prediction, or prediction of any other KPIs, using an AI model, with the output deployed to the VBBU, in some embodiments. The identification of the required parameters can be limited to the parameters that are available at the VBBU, in some embodiments. So in the example of the energy usage prediction embodiment, parameters such as: number of connected UEs; data rates; usage pattern; RF load; CPU load; etc. are eligible for use with the AI lookup table, in some embodiments.

In some embodiments, the AI/ML models may be deployed on RU (radio unit) or CU (centralized unit). In some embodiments, the AI/ML models could be deployed as xApps (on a near-RT RIC) or as rApps (on a non-RT RIC), in the 5G and/or ORAN-compatible architecture. The outputs of any of these models could be deployed to the vBBUs as AI lookup tables, in some embodiments.

In some embodiments, AI/ML models could be deployed for handling cases that do not appear in the AI lookup tables at the vBBU. This could include edge cases and cases that do not fit the heuristics, in some embodiments. In some embodiments, the AI/ML models could be deployed in the non-RT RIC or other core nodes, and queries could be sent to them for processing. In some embodiments, AI/ML models could receive training data via the O1 interface at the non-RT RIC. In some embodiments, AI/ML models could be queried using real-time output data from the Al interface via the near-RT RIC. In some embodiments, the AI/ML models could be upgraded or deployed using containers at the RIC.

In some embodiments, containers may be used, as described elsewhere herein. In some embodiments, one or more network functions as described herein may be provided by virtualized servers, which may be provided using containerization technology. Containers decouple applications from underlying host infrastructure. This makes deployment easier in different cloud or OS environments. A container image is a ready-to-run software package, containing everything needed to run an application: the code and any runtime it requires, application and system libraries, and default values for any essential settings. Containers may include the use of Kubernetes or other container runtimes.

In Kubernetes, a pod (as in a pod of whales or pea pod) is a group of one or more containers, with shared storage and network resources, and a specification for how to run the containers. A Pod's contents are always co-located and co-scheduled, and run in a shared context. A Pod models an application-specific “logical host”: it contains one or more application containers which are relatively tightly coupled. In non-cloud contexts, applications executed on the same physical or virtual machine are analogous to cloud applications executed on the same logical host. Pods are configured in Kubernetes using YAML files.

For example, a controller for a given resource provided using containers handles replication and rollout and automatic healing in case of Pod failure. For example, if a Node fails, a controller notices that Pods on that Node have stopped working and creates a replacement Pod. The scheduler places the replacement Pod onto a healthy Node.

The use of containerized technologies is rapidly spreading for providing 5G core (5GC) technologies. The present disclosure is deployed using containerized technologies, in some embodiments.

Further details regarding some embodiments may be found in U.S. Pat. App. Publication Nos. US20200045565A1 and US20200042365A1, each of which are hereby incorporated by reference in their entirety for all purposes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 512 and 514, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 502 for reconfiguration.

Other elements and/or modules may also be included, such as a home eNodeB, a local gateway (LGW), a self-organizing network (SON) module, or another module. Additional radio amplifiers, radio transceivers and/or wired network connections may also be included.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for providing a Real-Time PHY model at a RAN edge, comprising:
running an Artificial Intelligence (AI) model on a general purpose processor in a cloud using telecommunications data as inputs, to generate outputs;
storing the inputs and the outputs in a lookup format to facilitate lookup, without storing the AI model concurrently;
deploying the stored inputs and outputs in the lookup format to a Virtual Base Band Unit (VBBU); and
using in-memory lookup of parameters at the VBBU of real time telecommunications data.

2. The method of claim 1, further comprising storing the inputs and the outputs with compression.

3. The method of claim 1, further comprising refreshing the stored inputs and outputs by re-running the AI model periodically and deploying a new lookup format to the VBBU.

4. The method of claim 1, wherein the telecommunications data is radio frequency physical layer data.

5. The method of claim 1, wherein the telecommunications data is 4G or 5G media access control (MAC) layer data.
